(19) United States
(12) Patent Application Publication
(10) Pub. No.: US 2026/0367329 A1
(43) Pub. Date: Nov. 19, 2026

(54) Scalable All-Optical Switch Platform

(71) Applicant: Ciena Corporation, Hanover, MD (US)

(72) Inventors: David W. Boertjes, Nepean (CA); Fabien Colton, Kars (CA); Daniel Rivaud, Ottawa (CA)

(73) Assignee: Ciena Corporation, Hanover, MD (US)

(21) Appl. No.: 19/206,179

(22) Filed: May 13, 2025

(51) Int. Cl. G02B 6/35; G02B 6/38; G02B 6/44

(52) U.S. Cl. CPC G02B 6/356; G02B 6/3542; G02B 6/3586; G02B 6/3885; G02B 6/44526

(57) ABSTRACT

An optical switching network element includes a centralized shuffle module interconnected via multi-fiber optical cables to multiple optical circuit switch (OCS) modules, collectively forming a scalable all-optical switch platform. A flexible optical backplane or mechanical backplane supports modular connectors and multi-fiber trunk cables, simplifying installation, maintenance, and expansion. Expanded beam optical (EBO) connectors enhance reliability by providing contamination resistance and simplified blind-mate connectivity. The shuffle module integrates ingress/egress connections, reducing complexity of fiber routing, and allows field reconfiguration or replacement without extensive re-cabling. Optical switching capacity is incrementally scalable by adding or upgrading OCS modules of varying sizes and radix. The design accommodates diverse deployment environments, including liquid-cooled and non-liquid-cooled racks, standard telecom racks, and Open Rack v3 configurations. This modular, future-proof architecture significantly improves operational efficiency, reliability, maintainability, and scalability of optical networks for high-performance data centers supporting advanced computing applications.

### FIELD OF THE DISCLOSURE

The present disclosure relates generally to networking. More particularly, the present disclosure relates to systems and methods for a scalable all-optical switch platform or network element architecture.

### BACKGROUND OF THE DISCLOSURE

An Optical Circuit Switch (OCS) is a network device that provides dynamic, optical-layer switching of fiber optic signals without electronic conversion. An example implementation of OCS technology in data centers is for artificial intelligence (AI) training clusters, such as using OCSs to dynamically interconnect clusters of Tensor Processing Units (TPUs), forming various optimized topologies tailored to specific computational tasks. Additionally, OCSs facilitate flexible, efficient interconnection of smaller sub-clusters configured for job-specific requirements. For example, an OCS can be deployed in a rack-mounted configuration with various modules, chassis, cards, etc. (collectively referred to herein as “modules”). Existing systems for optical connectivity heavily rely on manually cabling each module directly to every other module. This conventional approach creates significant challenges related to complexity, cost, labor intensity, scalability, field maintenance, and expansion difficulties due to extensive fiber optic cabling requirements. Simplifying this operational deployment would clearly yield significant practical advantages.

### BRIEF SUMMARY OF THE DISCLOSURE

The present disclosure relates to a scalable all-optical switch platform or network element architecture employing a centralized shuffle module and multiple optical circuit switch (OCS) modules interconnected through an optical backplane using multi-fiber trunk cables and connectors. The architecture simplifies the complexity, deployment, and maintenance issues associated with conventional point-to-point fiber cabling approaches. A configurable shuffle module centralizes ingress and egress optical connectivity, enabling easy, incremental scaling of switching capacity through the addition or upgrading of individual OCS modules without necessitating reconfiguration of existing optical infrastructure. Expanded beam optical (EBO) connectors provide robust, contamination-resistant connectivity and facilitate blind-mate connections for simplified installation. A mechanical backplane structure further enhances flexibility, allowing field-configurable optical and electrical interconnections. The disclosed platform supports diverse deployment scenarios, including varying rack standards and cooling configurations, substantially enhancing operational reliability, scalability, maintainability, and adaptability within high-performance computing and data center environments..

### BRIEF DESCRIPTION OF THE DRAWINGS

The present disclosure is illustrated and described with reference to the various drawings. Like reference numbers are used to denote like components/steps, as appropriate. Unless otherwise noted, components depicted in the drawings are not necessarily drawn to scale.

FIG. 1 illustrates a front view of a scalable all-optical switch platform housed within a rack.

FIG. 2 illustrates a block diagram of logical connectivity between the shuffle module and the various OCS modules.

FIGS. 3 and 4 illustrate an example optical backplane for the switch platform with FIG. 3 being a front view where the modules interconnect and FIG. 4 being a rear view where there is optical fan out between the shuffle module and all of the OCS modules.

FIG. 5 illustrates the scalable all-optical switch platform incorporating front cabling as an alternative embodiment to the previously described optical backplane in FIGS. 3 and 4.

FIG. 6 illustrates the all-optical switch platform in the rack with an OCS module equipped and three unequipped slots.

FIG. 7 illustrates the all-optical switch platform with different sized OCS modules.

FIGS. 8 – 11 illustrate various views of an OCS module where FIGS. 8 and 9 are front and rear perspective views, FIG. 10 is a top view, and FIG. 11 is a front view.

FIGS. 12 – 15 illustrate various views of a shuffle module where FIGS. 12 and 13 are front and rear perspective views, FIG. 14 is a top view, and FIG. 15 is a front view.

FIGS. 16 – 25 illustrate various views of an example implementation of a scalable all-optical switch platform, with a mechanical backplane.

FIG. 26 illustrates a flowchart of a process of expanding capacity of an optical switching network element.

### DETAILED DESCRIPTION OF THE DISCLOSURE

Physical design considerations—particularly with respect to reliability, ease of deployment, and maintainability—have been insufficiently addressed in all-optical network configurations. Specifically, the following issues persist:
(1) The large number of individual fibers involved creates significant logistical and maintenance challenges. Further complicating matters is the inherent complexity of shuffle interconnects—fiber arrangements involving crossing paths—making manual deployment, troubleshooting, and maintenance extremely challenging. The complexity of shuffle interconnects precludes effective usage of standardized multi-fiber solutions such as Multi-Fiber Push On (MPO) or similar connectors, and consequently, an alternative approach enabling these multi-fiber solutions would greatly streamline deployment and maintenance operations.
(2) Existing fiber connectivity solutions predominantly rely on single-fiber connectors, significantly constraining available faceplate space. For instance, a conventional 300x300 OCS installation requires approximately 600 individual fiber connectors, occupying roughly 6 to 8 rack units (RU) of valuable faceplate space. This requirement often exceeds the spatial footprint of the modules themselves, resulting in suboptimal space utilization. Solutions enabling more compact, multi-fiber connector utilization would yield substantial improvements in spatial efficiency.
(3) Replacement and servicing of optical switch modules present considerable operational difficulties. The intricate disconnection and reconnection processes involving numerous fibers are both time-consuming and error-prone. Developing an approach that simplifies these tasks by minimizing required actions and duration would significantly enhance serviceability.
(4) Increasingly demanding interconnection requirements necessitate either the use of larger radix switches—which elevate the severity and extent of potential failures—or the deployment of numerous smaller switches arranged into multiple switching planes. This proliferation complicates coordination, management, and operational oversight. Therefore, developing solutions capable of effectively accommodating increased interconnect demands in a streamlined and consolidated manner would be highly advantageous.

In optical networking, historically, challenges such as optical power management, dispersion, and complexity were largely confined to long-haul networks spanning hundreds or thousands of kilometers. However, these same challenges are now emerging even at significantly shorter scales—down to just tens of meters. As a result, advanced optical technologies, including OCS and Wavelength Division Multiplexing (WDM), are becoming increasingly essential within data centers, facilitating high-capacity, low-latency interconnects at row-to-row and rack-to-rack levels. This trend is expected to persist and intensify, ultimately driving optical interconnects to progressively shorter distances, reaching box-to-box and even chip-to-chip communication on the near horizon.

The present disclosure specifically addresses numerous operational, deployment, and reliability challenges encountered when deploying advanced optical technologies within and between data centers. A significant hurdle in leveraging fully optical systems at such reduced scales involves managing an unprecedented density of optical connections—typically 10 to 100 times higher than the number of individual fibers and ports found in conventional transmission networks. The traditional manual handling, routing, and installation of these fibers presents substantial operational difficulties. Specifically, the physical processes involved in installation, meticulous fiber-end cleaning, and ongoing maintenance become exceedingly labor-intensive, costly, and prone to human errors at these unprecedented connection densities.

Another key challenge addressed herein relates directly to the intended application of optical technologies in modern data centers, particularly in supporting large-scale artificial intelligence and machine learning (AI/ML) workflows. These workloads frequently involve extensive training processes for Large Language Models (LLMs) and other sophisticated AI models, utilizing massive datasets that demand high-performance computational clusters including tens to thousands of Graphics Processing Units (GPUs) or TPUs (collectively referred to herein as xPUs). These xPU clusters are interconnected through a combination of electrical interconnects, where shorter distances permit cost-effective and efficient solutions, and optical interconnects, which become essential for spanning greater distances or achieving higher bandwidths.

Crucially, the reliability and availability of the optical networking infrastructure supporting these xPU clusters directly impact operational efficiency and overall costs. Failures within these optical networks can severely disrupt AI training jobs, potentially causing multi-hour or multi-day computations to fail prematurely, necessitating costly restarts from earlier checkpoints. Thus, maintaining a highly reliable, easily maintainable optical interconnection system with minimized failure impact—also known as a limited "blast radius"—is essential for effective data center operations. The approach proposed herein provides solutions specifically aimed at enhancing the reliability, maintainability, and scalability of optical deployments within these challenging, high-performance computing environments.

### All-Optical Switch Platform

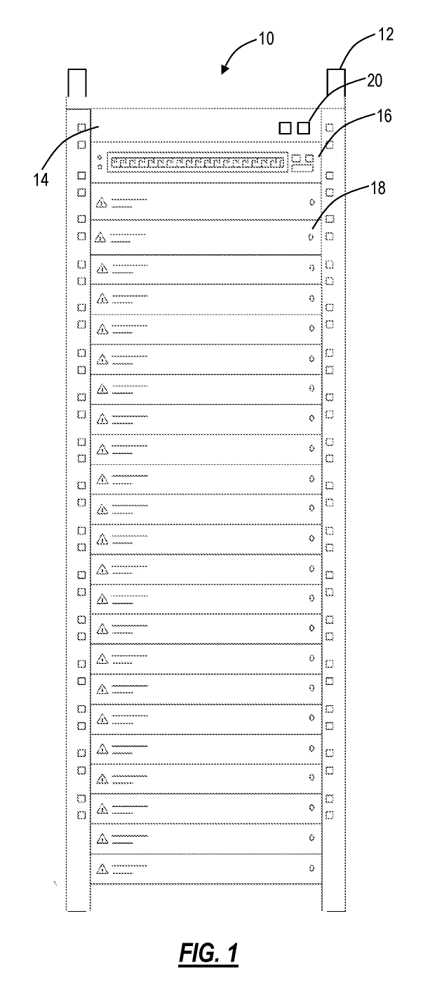

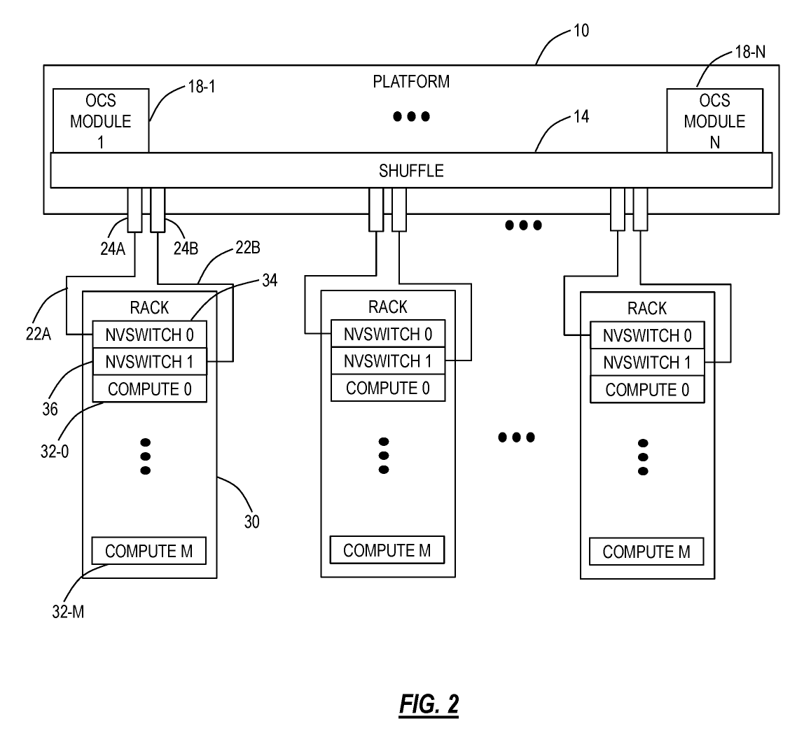

The present disclosure describes a scalable all-optical switch platform, also referred to as a network element architecture for an OCS, specifically designed to overcome deficiencies inherent in conventional optical switching systems. FIG. 1 illustrates a front view of a scalable all-optical switch platform 10 housed within a rack 12. In an example embodiment, the switch platform 10 includes a control module 14 responsible for overall management and coordination, a shuffle module 16 facilitating optical interconnections, and a plurality of individual OCS modules 18 which provide the core switching functionality. The primary objectives of the disclosed switch platform 10 include simplified operational deployment, enhanced reliability, improved maintainability under real-world field conditions, and significant reductions in complexity and associated deployment and maintenance costs.

To achieve these objectives, the disclosed switch platform 10 includes several key aspects and advantageous design considerations:
(1) The switch platform 10 employs a simplified optical backplane structure enabling scalable, configurable, and maintainable interconnections among OCS modules 18 through the shuffle module 16. While the platform can be pre-configured for initial deployment, a key advantage of this approach is its inherent flexibility—allowing for a "cable-as-you-grow" strategy and straightforward replacement of damaged or faulty cables in the field without extensive operational disruption.
(2) Sub-system elements, specifically the OCS modules 18, provide inherent scalability. Connectivity can be expanded incrementally by increasing the vertical slot count, all without requiring any modifications to the backplane itself. This flexible design approach supports the integration of OCS modules of varying radix sizes into differently sized modules, optimizing space and resource usage in line with growth requirements.
(3) The disclosed platform 10 is future-proof, enabling straightforward adaptation to evolving network requirements and configurations. Rear cabling accessibility ensures that reconfigurations can be performed easily and quickly, adapting seamlessly to new optical networking demands or technological advances as they arise.
(4) Interconnections between sub-system elements (OCS modules 18) through the backplane substantially simplify maintenance procedures. Individual modules can be serviced or replaced without necessitating complex re-cabling or re-fibering operations, minimizing downtime and reducing opportunities for maintenance-related errors.
(5) The shuffle module 16 is designed as an integrated, field-replaceable component capable of accommodating a wide variety of configurations. It can be customized to meet specific application needs, such as differing numbers of interconnected OCS modules 18, or variations in the base radix (number of ports) of the individual OCS modules 18. This modular approach simplifies upgrades, repairs, and customization according to changing operational requirements.
(6) Recognizing diverse deployment environments, including potential deployment within Open Rack v3 (ORv3) racks, the OCS modules 18 and the associated optical backplane are engineered for compatibility with both liquid-cooled (LC) and non-liquid-cooled (non-LC) system configurations. This versatility ensures optimal operation across a wide range of thermal management and cooling infrastructure scenarios, enhancing applicability and longevity of the switch platform.
(7) The disclosed switch platform 10 is designed to be "dual rack" compatible, meaning it can be seamlessly deployed in traditional deep telecom racks (standard industry racks) or within ORv3-compliant racks without necessitating redesign or substantial modifications to the individual sub-system elements (e.g., OCS modules 18). This cross-platform compatibility significantly enhances the flexibility, adaptability, and overall practicality of the system, enabling streamlined inventory management and facilitating consistent operational practices across different deployment environments.

The control modules 14 perform essential control, monitoring, and management functions typically required in networking equipment, including Operations, Administration, Maintenance, and Provisioning (OAM&P) functionalities. These modules 14 are responsible for monitoring operational status, enabling configuration changes, detecting faults, and facilitating maintenance activities across the platform. To facilitate external communications, diagnostics, and management interactions, the control modules 14 include interface ports 20, such as Ethernet ports or other suitable network interfaces. Additionally, control modules 14 can provide hardware abstraction capabilities, simplifying the representation of underlying hardware resources, and present a northbound interface to external network management systems or software-defined networking (SDN) controllers. Through this northbound interface, comprehensive coordination and orchestration of all connected OCS modules 18 are achieved, enabling cohesive operational control and efficient resource allocation. Furthermore, the control modules 14 are engineered to support redundancy, ensuring high availability and fault tolerance by enabling rapid failover between redundant control components. Finally, they are designed for straightforward field replaceability, minimizing downtime and simplifying ongoing maintenance activities, thereby significantly improving overall platform reliability and maintainability.

FIG. 2 illustrates a block diagram depicting logical connectivity between the shuffle module 16 and the multiple OCS modules 18-1, 18-N. The shuffle module 16 significantly simplifies optical interconnections between external equipment, such as compute racks 30, and the individual OCS modules 18-1, 18-N. To achieve this, the shuffle module 16 consolidates all external-facing ingress and egress connections on its faceplate (as shown previously in FIG. 1) through the use of high-density, multi-fiber trunk cables 22A and 22B. These trunk cables 22A, 22B interface directly with corresponding ports 24A, 24B located on the shuffle module 16. Internally, the shuffle module 16 manages optical signal distribution using a shuffle interconnect architecture that fans out and redistributes incoming optical signals from external devices to the various OCS modules 18-1, 18-N via an optical backplane. Likewise, signals from the OCS modules are aggregated and routed back out to external devices through this same shuffle architecture.

The shuffle design can be tailored for various configurations. For instance, a single shuffle can be used for all modules, or it can be divided into multiple redundant halves (e.g., an "A-side" and "B-side"). The OCS modules 18 can connect via direct cables to the shuffle module 16, either through blind-mate optical backplane connectors or manual connectors.

For illustrative clarity, FIG. 2 demonstrates an example application scenario where the shuffle module 16 provides optical connectivity between external racks 30 housing computational resources 32-0 through 32-M—such as GPUs or TPUs (collectively referred to as xPUs)—via switches 34, 36 (such as an NVSwitch available from Nvidia). In this example, the shuffle module 16 enables dynamic optical-layer switching, allowing efficient and flexible interconnection among these high-performance computational elements. However, it should be understood that this illustrated arrangement is representative rather than limiting. Numerous alternative applications and interconnection scenarios are readily conceivable, extending the applicability of the disclosed shuffle module 16 and associated OCS modules 18 to various other optical networking configurations and topologies.

The trunk cable interconnect provides efficient optical connectivity between the compute racks 30 and the scalable all-optical switch platform 10. These trunk cables 22A, 22B may incorporate fiber concentrators at the racks to streamline and simplify routing of individual fibers or multi-fiber cables originating from the computational resources, such as xPUs, into the trunk cables 22A, 22B. Conventionally, interconnections between xPU racks and optical switching layers form complex mesh arrangements, commonly referred to as shuffle interconnects. By integrating an optical shuffle functionality directly within the OCS platform 10 via the shuffle module 16, this traditionally complex interconnection becomes significantly simplified. Specifically, connections from external xPU racks 30 to the OCS platform 10 become straightforward, straight-through connections, enabling effective use of high-density multi-fiber trunk cables 22A, 22B. For instance, an expanded beam optical (EBO) connector such as the EBO-144 can consolidate and interconnect 144 fibers using a single connector at each cable end, i.e., the ports 24A, 24B, drastically reducing complexity, improving spatial efficiency, and simplifying deployment.

Again, central to this interconnection architecture is the integrated shuffle module 16, which employs advanced multi-fiber connectors, notably EBO connectors. The shuffle module 16 serves as a pivotal component in simplifying optical connectivity, significantly easing operational complexity associated with interconnecting external racks to the OCS modules 18-1, 18-N. Importantly, the shuffle module 16 is configurable to address various specific applications and operational scenarios, such as differing numbers of interconnected racks or varying fiber counts per rack. Its design further enables deployment of multiple shuffle modules to independently serve distinct subsets or subsystems of OCS modules. Additionally, to enhance operational robustness and flexibility, the integrated shuffle module 16 is engineered to be field replaceable, facilitating straightforward maintenance and upgrades without extensive re-cabling or operational downtime.

### Optical Backplane

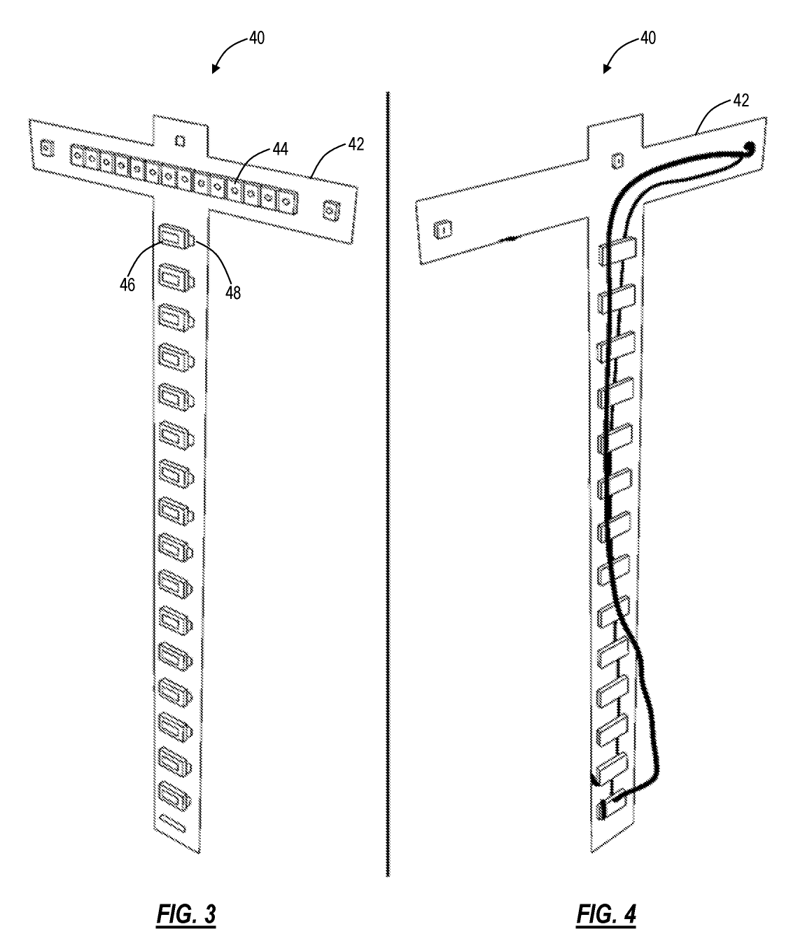

FIGS. 3 and 4 illustrate an example optical backplane 40 for the disclosed scalable all-optical switch platform 10. FIG. 3 provides a front view depicting interconnections among the control module 14, shuffle module 16, and multiple OCS modules 18, while FIG. 4 offers a rear view illustrating the optical fan-out connectivity extending from the shuffle module 16 to the various OCS modules 18. Specifically, the optical backplane 40 includes a support board 42 with designated areas for blind-mate optical connectors 44, 46. A horizontal row of blind-mate optical connectors 44 is positioned to interface with the shuffle module 16, while vertically aligned individual blind-mate optical connectors 46 provide connections for each of the OCS modules 18. In one embodiment, the optical backplane 40 is designed as an independent optical interconnect platform, decoupled from other system-level connectivity such as communications interfaces for control signals, power distribution, or liquid cooling conduits. Alternatively, in another embodiment, the board 42 is equipped with configurable regions capable of supporting blind-mate optical, electrical, and power interconnections within a unified structure, enhancing integration and deployment flexibility.

FIG. 3 depicts blind-mate expanded beam optical (EBO) connectors 46, arranged in pairs per row, along with accompanying electrical connectors 48 that deliver both communication signals and power. FIG. 4 demonstrates representative cabling illustrating the shuffle connections extending from the shuffle module 16 to the multiple OCS module 18 slots. The optical shuffle is realized through point-to-point multi-fiber trunk cables, mirroring the simplified connections used between external racks and the shuffle module. Conventionally, shuffle functionality is directly integrated into a rigid backplane structure; however, the disclosed approach separates the shuffle functionality from the backplane 40. By utilizing mechanically constrained trunk cables routed along the backplane, this design provides several significant advantages:

Firstly, enhanced configurability is achieved by enabling flexible capacity expansion. For instance, initial deployments could include a single EBO-144 trunk cable per slot, providing fiber connectivity sufficient for supporting 72x72 port configurations per OCS module 18 slot. If higher density is required, an additional trunk cable can be installed per slot—either at the factory during initial assembly or in the field as operational requirements evolve—thereby doubling connectivity to accommodate 144x144 configurations. This incremental scalability significantly improves adaptability and cost-efficiency.

Secondly, the cable-based architecture markedly improves repairability and maintainability. In the event of an operational failure of a cable or connector, individual cables can be conveniently removed and replaced by operators without disrupting the ongoing operation of adjacent modules or affecting overall system uptime. This modular, field-serviceable approach significantly reduces downtime and maintenance complexity.

Another inherent advantage of employing standard trunk cables 22A, 22B rather than fixed optical waveguide structures in planar backplane substrates is the use of industry-standard optical fibers. This avoids the complexities and high manufacturing costs associated with intricate planar optical waveguide technologies.

Finally, utilizing flexible trunk cables 22A, 22B as the distribution medium on the optical backplane 40 inherently provides compliance for blind-mate connectors. This compliance translates into reduced mechanical constraints, as connectors can slightly shift or realign due to the inherent flexibility of the fiber cables themselves, thus simplifying the mechanical design, reducing alignment tolerances, and enhancing overall robustness and reliability of optical connections within the switch platform 10.

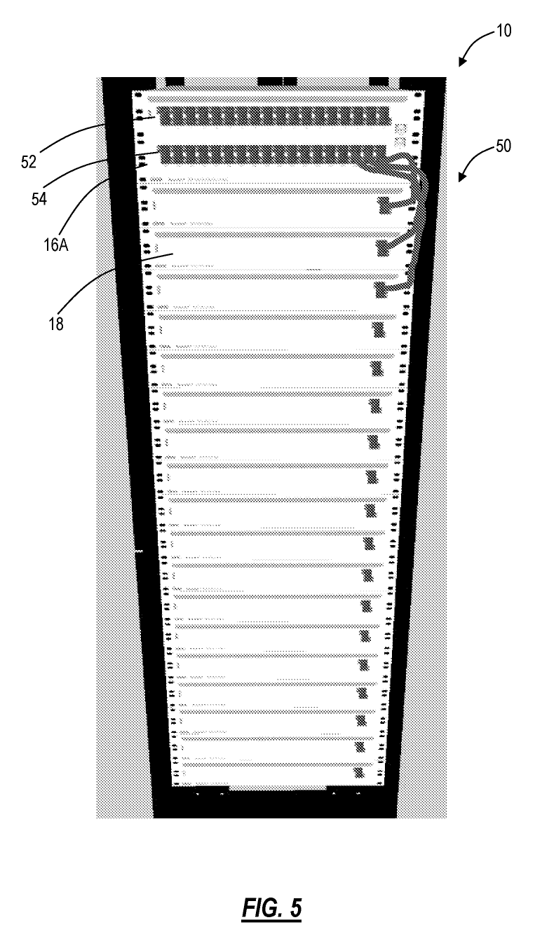

FIG. 5 illustrates the scalable all-optical switch platform 10 incorporating front cabling 50 as an alternative embodiment to the previously described optical backplane 40. In this embodiment, rather than relying on blind-mate connections via EBO connectors at the rear, the trunk cables can instead be routed and managed directly from the front side of the platform, significantly simplifying access and serviceability. To facilitate this front-cabled arrangement, the switch platform 10 includes an enlarged, double-sized shuffle module 16A that integrates two distinct sets of connectors 52, 54 on its front face. The first set of connectors 52 provides ingress and egress connectivity to external compute racks 30, while the second set of connectors 54 is dedicated to optical connectivity for each of the individual OCS modules 18 housed within the platform. Internally, the shuffle module 16A is equipped with pre-arranged cabling or optical pathways that establish required shuffle interconnections between these two connector sets 52, 54, effectively managing the optical signal distribution. This integrated shuffle arrangement simplifies external and internal cabling complexity, enabling easier operational maintenance, upgrades, and repairs, and enhancing flexibility for deployment configurations. This front-access approach also streamlines operational procedures and reduces downtime by facilitating rapid reconfiguration and servicing activities directly from the easily accessible front panel.

In an alternative embodiment, the optical backplane 40 may be implemented with standard connectors for trunk cables that directly interconnect the shuffle module 16 and the OCS modules 18, instead of relying exclusively on blind-mate connectors. While the previously described embodiments utilize traditional backplane fabrication methods integrating electrical interconnections within printed circuit board (PCB) layers, an alternative and more flexible solution involves the use of a purely mechanical backplane structure. Such a mechanical backplane primarily serves as a robust mechanical framework and alignment structure, supporting optical and electrical connectors without embedding connectivity directly within PCB layers. This approach significantly enhances configurability and adaptability, enabling efficient pre-configuration of optical and electrical connections at the factory to precisely meet initial customer system specifications.

Moreover, the mechanical backplane architecture inherently allows for straightforward in-field modifications and upgrades. For instance, operators can readily adjust or expand optical and electrical interconnections at customer premises, significantly simplifying maintenance, scaling, and reconfiguration activities. Alternatively, the mechanical backplane may be initially provided fully populated with the complete set of optical and electrical connectors, accommodating multiple potential system configurations within a single deployment. Such a comprehensive connector layout facilitates flexible optical and electrical harness reconfiguration on-site with minimal effort and downtime, thus minimizing customer operational disruption and reducing service complexity. This mechanical backplane concept effectively supports both rapid deployment and long-term maintainability, ensuring the all-optical switch platform 10 remains versatile and responsive to evolving customer requirements and technological advancements..

### OCS Module

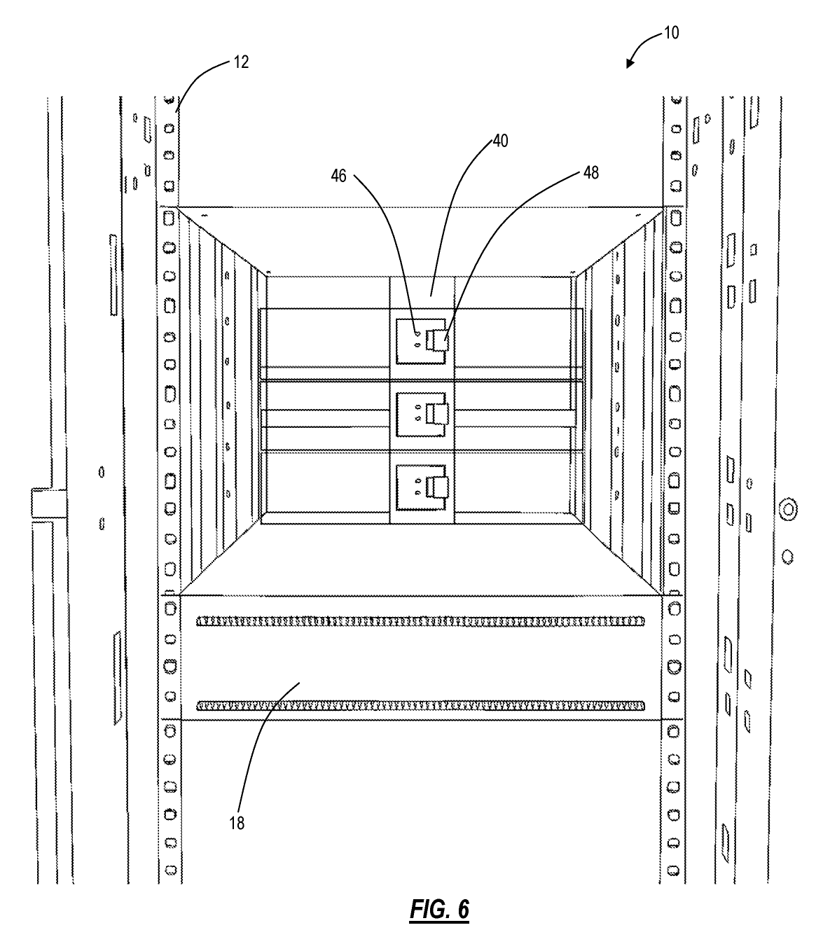

FIG. 6 illustrates the scalable all-optical switch platform 10 installed within a rack 12, depicting one equipped OCS module 18 along with three unequipped module slots. Each of the OCS modules 18 is configured as an X-by-X optical circuit switch, where X > 1, and is optically interconnected via the shuffle module 16, collectively forming a significantly larger optical switch architecture, namely the all-optical switch platform 10. This combined arrangement can effectively implement a Y-by-Y optical switching configuration, where Y > X, thus substantially scaling the total available switching capacity beyond individual module capabilities. Each OCS module 18 interfaces through a set of blind-mate optical and electrical connectors 46, 48 provided on the optical backplane 40, which facilitate the use of high-density EBO trunk cables to efficiently and reliably interconnect each OCS module 18 to the central shuffle module 16.

In an example embodiment, the rack 12 is configured as a 38 Rack Unit (RU) system compatible with ORv3 specifications. Within this configuration, the shuffle module 16 can interface with external compute racks 30 utilizing two high-density EBO trunk cables, each capable of supporting 144 fiber connections, providing an aggregate connectivity of 2 × 144 fibers. The physical height of the individual OCS modules 18 may vary depending on the radix, or port count, of their internal optical switching plane (X-by-X). For instance, in one embodiment, a 2RU-sized OCS module 18 supports an optical switching capacity of 72-by-72 ports (X = 72). In another embodiment, a 4RU-sized OCS module 18 can support a larger optical switching capacity of 144-by-144 ports (X = 144). Accordingly, each OCS module 18 includes a proportional number of blind-mate optical connectors on its rear face, aligned to match corresponding connectors 46, 48 located on the optical backplane 40. FIG. 6 illustrates clearly how these module slots and their connectors are arranged to align precisely, providing efficient and robust connectivity when modules are inserted into the rack 12.

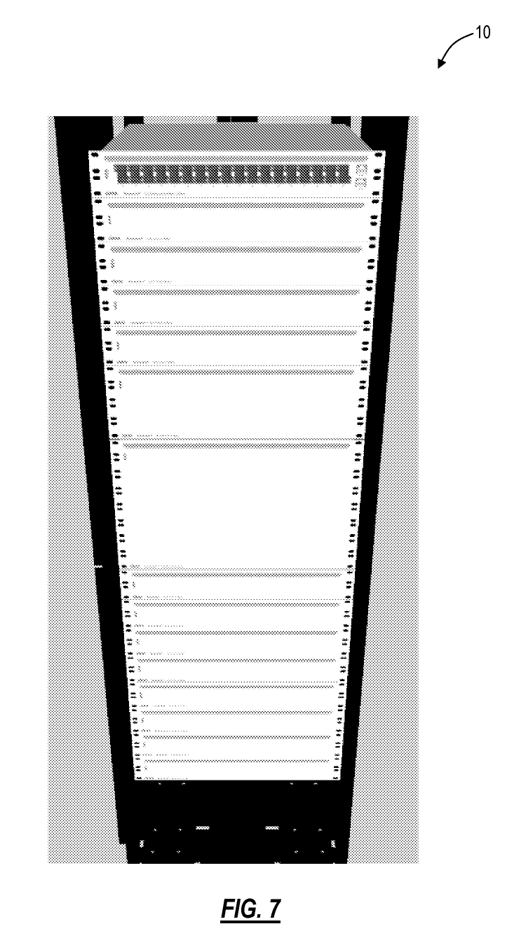

Notably, the optical backplane 40 design is intentionally flexible, allowing OCS modules 18 to occupy multiple adjacent slots, thus effectively aggregating their optical connectivity. Specifically, by spanning two or more slots, an OCS module 18 can achieve proportionately greater optical capacity through increased backplane connectivity—for example, occupying two slots doubles the optical connectivity. Consequently, larger OCS modules 18 are capable of supporting higher radix switching planes, scaling approximately linearly with physical size (e.g., 2RU = 72-by-72 ports, 4RU = 144-by-144 ports, 8RU = 288-by-288 ports, etc.). Although FIG. 1 previously depicted uniform OCS module sizing for simplicity, alternative embodiments explicitly support the coexistence and mixed deployment of OCS modules having different radix and physical sizes within the same rack 12. FIG. 7 further illustrates such an embodiment of the all-optical switch platform 10 where OCS modules 18 of varying sizes and capacities are integrated within a single, cohesive platform, enabling significant operational flexibility to address diverse switching requirements.

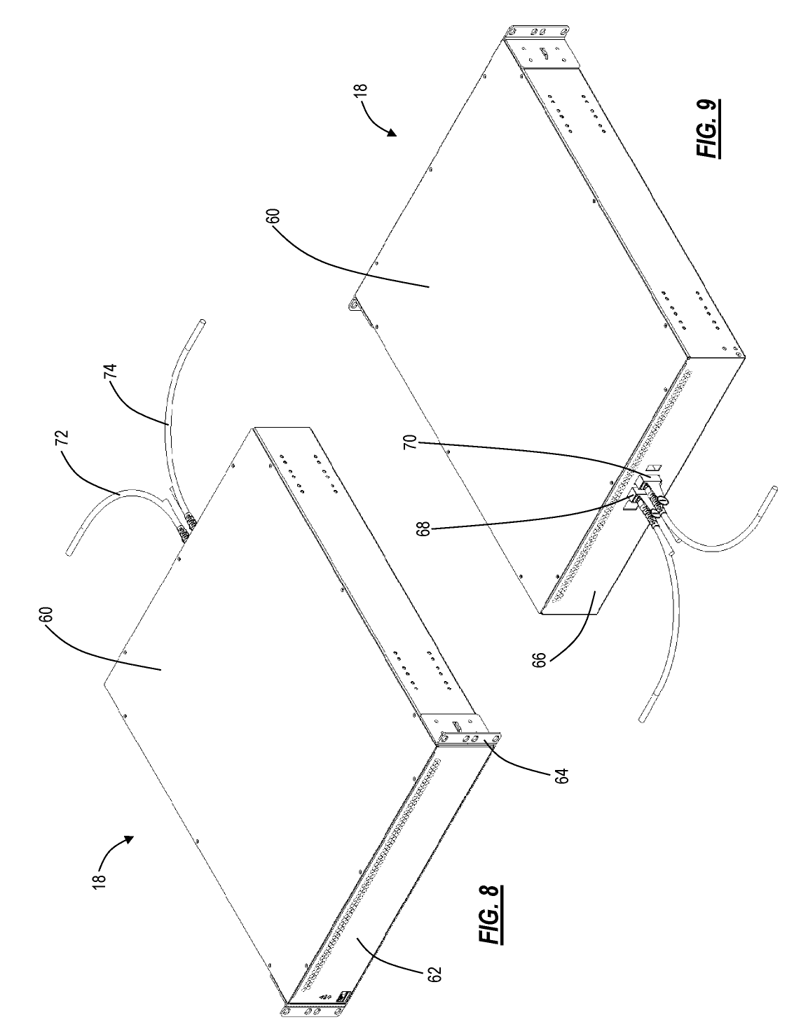

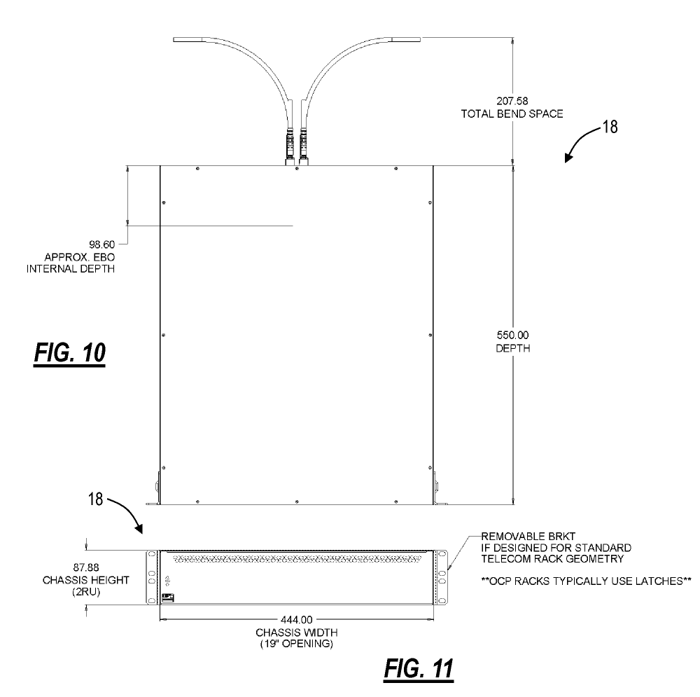

FIGS. 8 – 11 illustrate various views of an OCS module 18 where FIGS. 8 and 9 are front and rear perspective views, FIG. 10 is a top view, and FIG. 11 is a front view. The OCS module 18 includes a housing 60 with a faceplate 62, flanges 64 to connect to the rack 12, and a rear side 66 with connectors 68, 70 for attaching to the blind-mate connectors 46 on the optical backplane 40 or for attaching to trunk cables 72, 74 (as shown in FIGS. 8 and 9).

### Shuffle Module

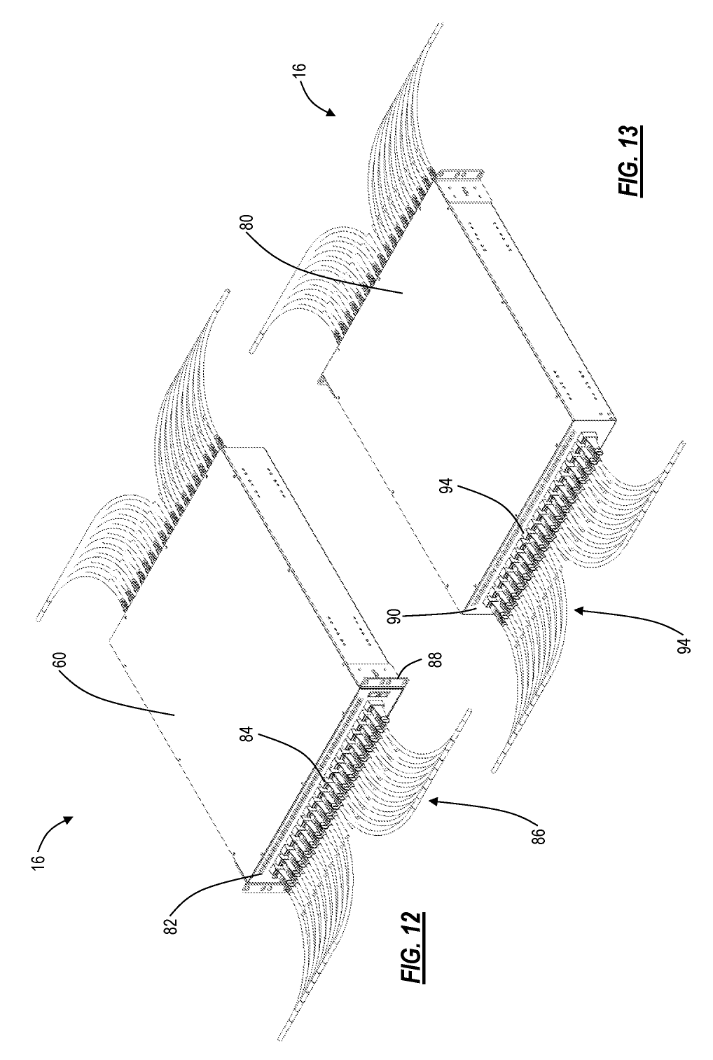

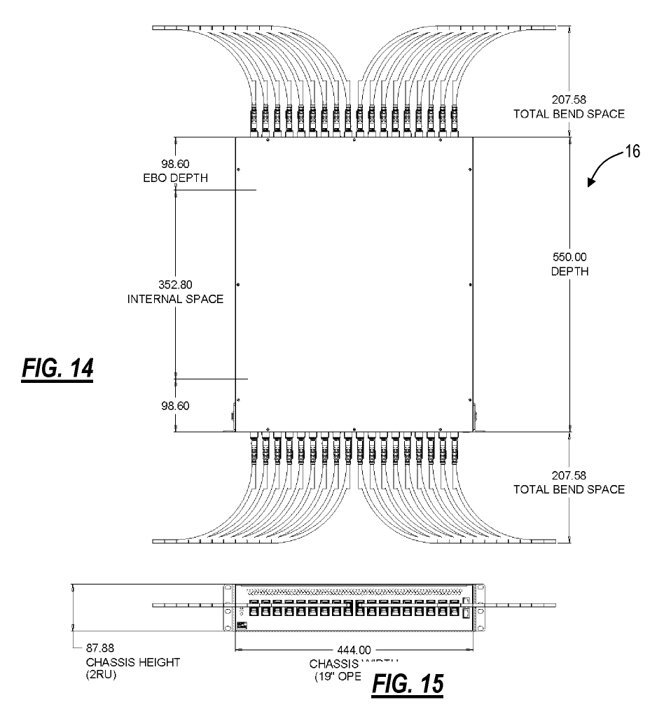

FIGS. 12 – 15 illustrate various views of a shuffle module 16 where FIGS. 12 and 13 are front and rear perspective views, FIG. 14 is a top view, and FIG. 15 is a front view. The shuffle module 16 includes a housing 80 with a faceplate 82 with connectors 84 for trunk cables 86 to connect to external devices, flanges 88 to connect to the rack 12, and a rear side 90 with connectors 92 for attaching to the blind-mate connectors 44 on the optical backplane 40 or for attaching to trunk cables 94 (as shown in FIGS. 12 and 13).

### Example System Implementation

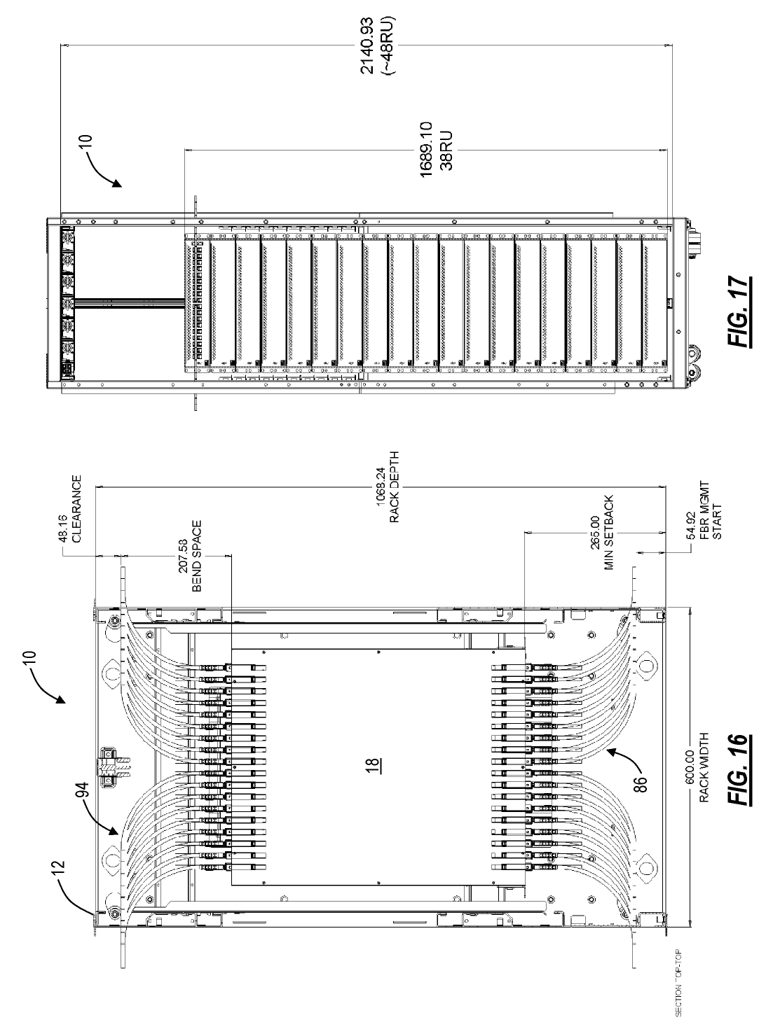

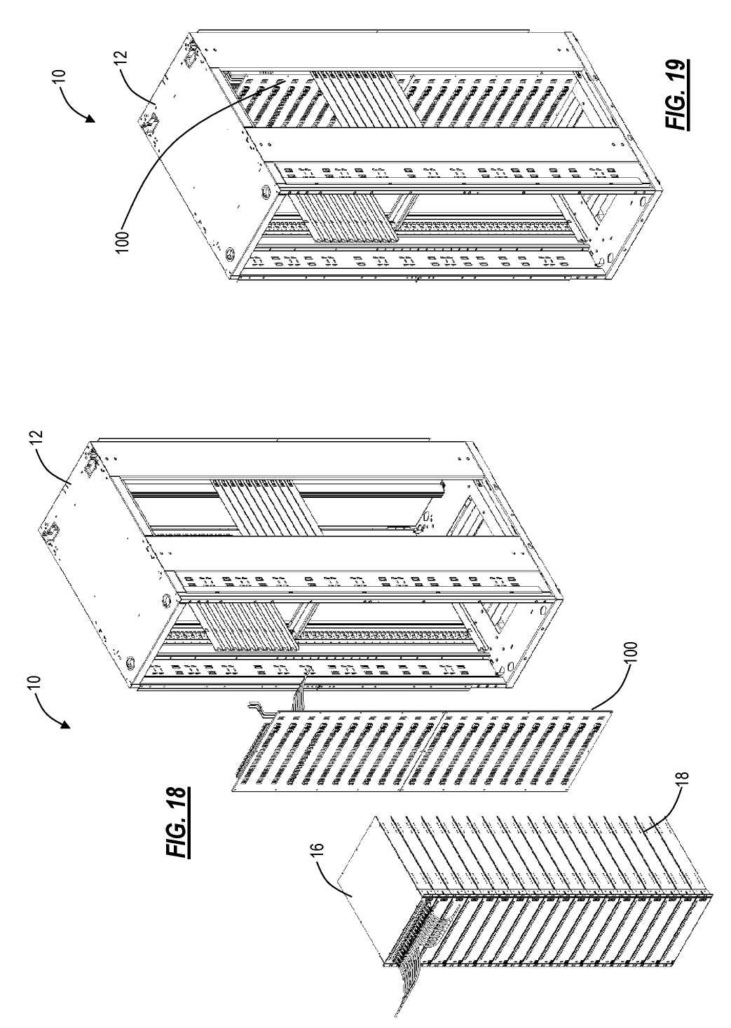

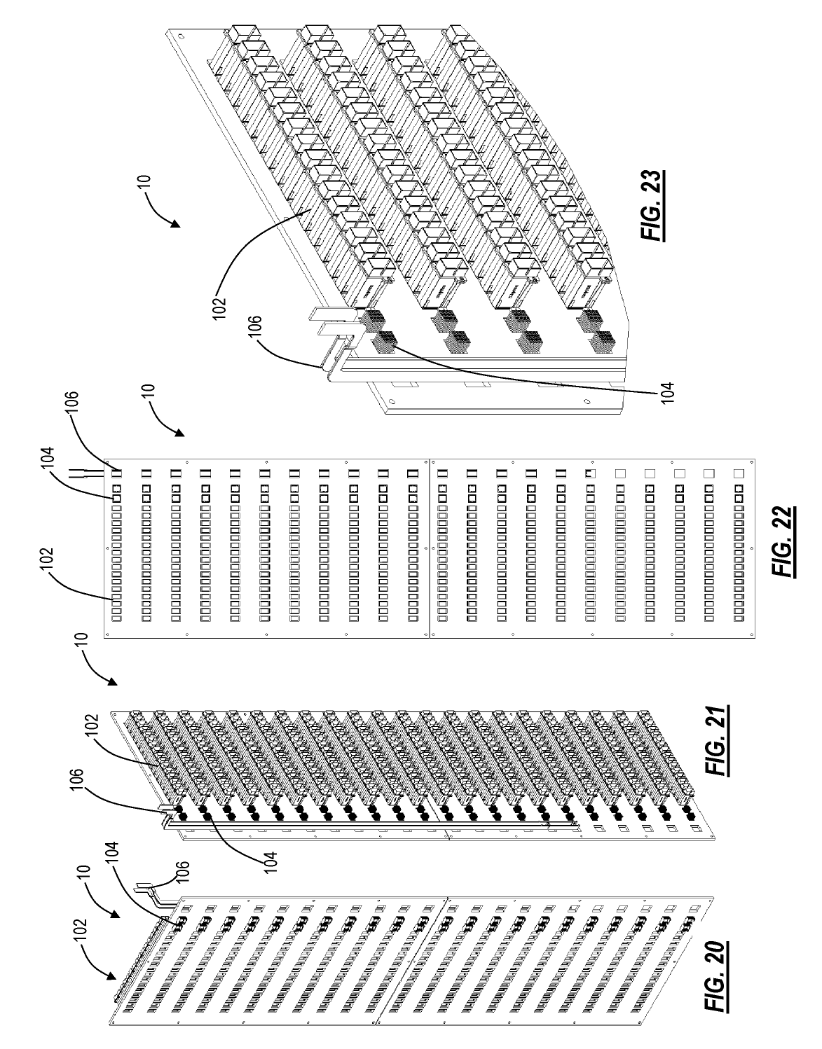

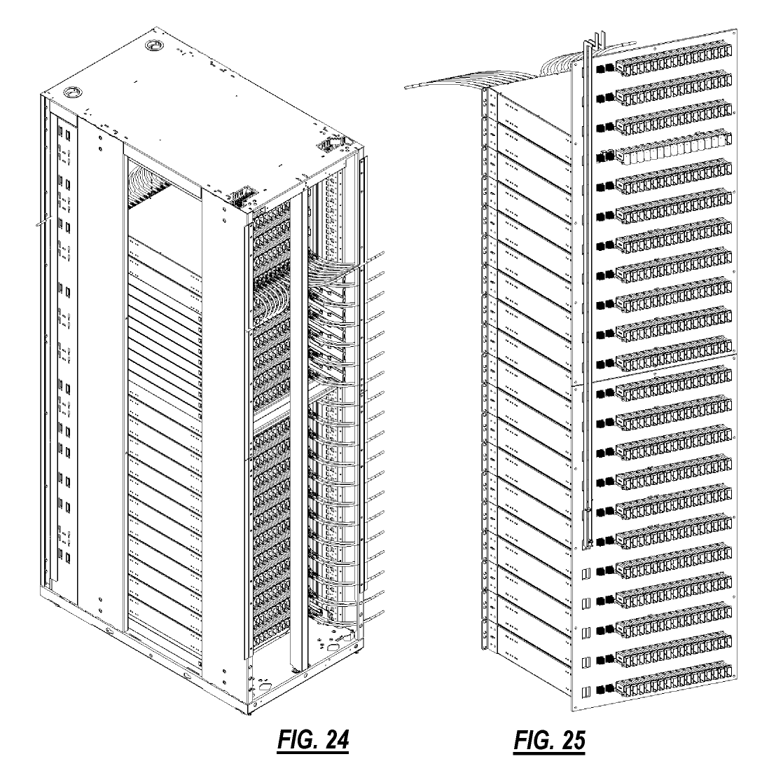

FIGS. 16 – 25 illustrate various views of an example implementation of a scalable all-optical switch platform 10, with a mechanical backplane 100. Those skilled in the art will appreciate this example implementation is presented for illustration purposes and other embodiments consistent with this various aspects disclosed here are contemplated. Specifically, this example implementation does not use blind-mate connections on the rear, but directly cable trunk cables. Also, other values are contemplated for the number of OCS modules 18.

FIG. 16 illustrates a top view of the rack 12. FIG. 17 illustrates a front view of the rack 12. FIG. 18 illustrates an exploded view of the scalable all-optical switch platform 10 with the rack 12, the modules 16, 18, and a mechanical backplane 100. FIG. 19 illustrates an assembled view of the rack 12 with the mechanical backplane 100.

FIGS. 20 – 23 illustrate various detailed views of the mechanical backplane 100, with FIG. 20 providing a front perspective view, FIG. 21 depicting a rear perspective view, FIG. 22 illustrating a front elevation view, and FIG. 23 presenting an exploded rear perspective view. The mechanical backplane 100 is structured into three distinct zones: an optical connector zone 102, an electrical connector zone 104, and a power distribution zone 106. The mechanical backplane 100 features uniformly patterned mounting locations at consistent spacing intervals (such as 1RU, 2RU, or other standard intervals) designed to accommodate a variety of OCS modules 18 and associated shuffle modules 16. This uniform mounting configuration greatly simplifies integration, allowing modules of different sizes or capabilities to be interchangeably positioned and secured into the backplane with minimal adjustments.

Optical and electrical connectors are mounted directly onto the mechanical backplane 100, providing stable and precise alignment for reliable connections. Significantly, the optical and electrical interconnections between individual OCS modules 18 and the central shuffle module 16 can be pre-configured during initial assembly and shipment to the customer, ensuring streamlined installation upon delivery. Alternatively, these connections can be configured or readily modified on-site at customer premises, granting substantial flexibility for system reconfiguration and expansion to meet evolving operational needs or technological advancements.

For power distribution, the illustrated embodiment employs a busbar arrangement integrated within the designated power zone 106. This busbar represents just one of several viable methods of delivering electrical power to the OCS modules. Alternative methods include dedicated power harnesses routed directly from external power supply units (PSUs). This modularity in power delivery options enhances the adaptability of the mechanical backplane 100, enabling customization to specific operational preferences or infrastructure requirements. Overall, this mechanical backplane design offers substantial advantages by facilitating easier module installation, rapid on-site reconfiguration, efficient scaling, and simplified maintenance activities, thereby ensuring high reliability and reducing downtime in data center environments.

FIG. 24 illustrates a rear perspective view of the scalable all-optical switch platform 10 in the rack 12, and FIG. 25 illustrates a rear perspective view of the scalable all-optical switch platform 10 without the rack 12.

### Optical Switching Network Element

In an embodiment, an optical switching network element is formed by the scalable all-optical switch platform 10. The optical switching network element includes a centralized shuffle module 18 having a plurality of ingress and egress optical connectors configured to interface with external equipment; a plurality of optical circuit switch (OCS) modules 16 each configured as an X-by-X optical switch, where X is greater than 1; and an optical backplane 40, 100 structure configured to optically interconnect the centralized shuffle module to each of the plurality of OCS modules 18 via optical connectors and multi-fiber optical cables, wherein the centralized shuffle module 16 provides optical shuffle functionality among the plurality of OCS modules 18.

The centralized shuffle module 16 includes integrated shuffle functionality configured to provide optical cabling between the ingress and egress connectors and the plurality of OCS modules 18. The optical connectors can include blind-mate optical connectors mounted on the optical backplane 40 structure. The optical connectors can include expanded beam optical (EBO) connectors. The optical backplane structure includes a mechanical backplane 100 supporting configurable arrangements of optical and electrical connectors. The mechanical backplane 100 enables pre-configuration of optical interconnections at a factory location and allows field reconfiguration of optical interconnections without altering the mechanical backplane structure. The mechanical backplane can include separate zones for optical connectivity, electrical connectivity, and power distribution.

Each of the plurality of OCS modules 18 is configured to occupy a configurable number of slots on the optical backplane, wherein occupying more slots increases available optical connectivity. The optical switching network element can further include at least one control module 14 configured to perform control, monitoring, and management functions, including operations, administration, maintenance, and provisioning (OAM&P). The centralized shuffle module 16 can be configured to be field replaceable without disruption of optical interconnections to the plurality of OCS modules 18. The optical backplane 40 supports incremental addition of optical cables and connectors to increase capacity, enabling cable-as-you-grow expansion.

The centralized shuffle module 16 includes connectors arranged in at least two distinct sets, a first set configured for connectivity to external compute racks, and a second set configured for internal connectivity to each OCS module 18. The centralized shuffle module 16 internally integrates optical cables configured to route optical signals between the first and second sets of connectors. The network element is configured to be deployed in at least one of a standard telecom rack and an Open Rack v3 (ORv3) rack without module redesign. Each OCS module 18 includes optical and electrical connectors arranged to align with corresponding connectors on the optical backplane for blind-mate connectivity. The optical connectors can include multi-fiber connectors supporting at least 144 fibers in a single connector, configured for high-density optical connectivity.

### Process

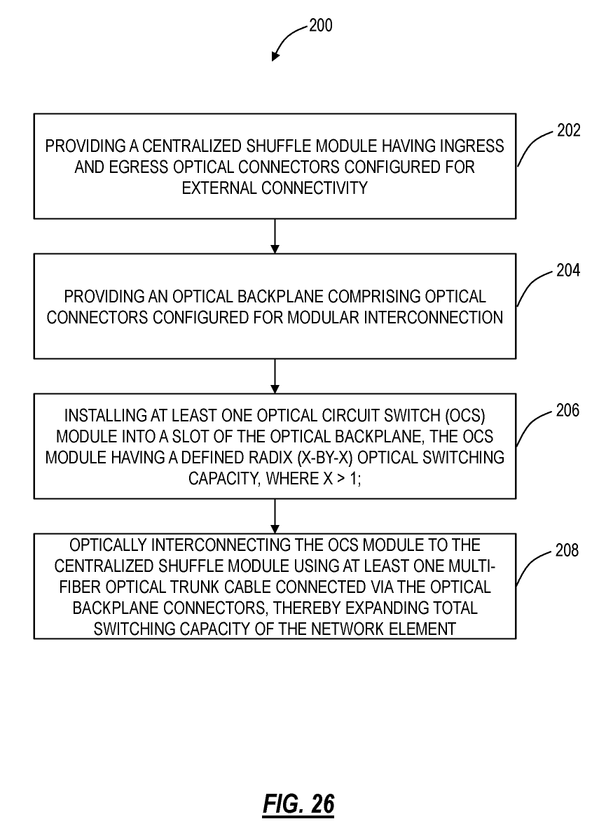

FIG. 26 illustrates a flowchart of a process 200 of expanding capacity of an optical switching network element. This process 200 includes providing a centralized shuffle module having ingress and egress optical connectors configured for external connectivity (step 202), and an optical backplane including optical connectors configured for modular interconnection (step 204). The process 200 further includes installing at least one optical circuit switch (OCS) module into a slot of the optical backplane, with the OCS module having a defined radix (X-by-X) optical switching capacity, where X > 1(step 206). Subsequently, the OCS module is optically interconnected to the centralized shuffle module using at least one multi-fiber optical trunk cable connected via the optical backplane connectors, thereby expanding total switching capacity of the network element (step 208).

In various embodiments, this process 200 includes incrementally installing additional OCS modules into available slots of the optical backplane to increase switching capacity over time, or installing OCS modules of different sizes and radix capacities within the same optical backplane, thereby forming a heterogeneous optical switching platform. Additionally, switching capacity may be upgraded by replacing an existing OCS module with another OCS module having a larger radix without requiring modifications to the optical backplane structure. Furthermore, additional optical trunk cables can be added per slot to double or otherwise enhance available connectivity between each installed OCS module and the centralized shuffle module.

The disclosed process 200 further provides for reconfiguring optical connections on-site by rearranging or replacing trunk cables interconnecting the OCS modules and the centralized shuffle module. In embodiments utilizing expanded beam optical (EBO) connectors, the method includes connecting these EBO connectors to corresponding blind-mate connectors on the optical backplane. This configuration allows for convenient replacement of damaged EBO connectors or trunk cables without disrupting operations of adjacent OCS modules.

Moreover, the process 200 encompasses pre-configuring optical connections between the centralized shuffle module and optical backplane at the factory prior to shipment, as well as field-configuring or modifying these optical connections after initial deployment. Installation of the OCS modules specifically includes aligning blind-mate connectors of each OCS module with corresponding connectors on the optical backplane, which simplifies deployment. The method may also simultaneously provide electrical power and data communication connectivity to each installed OCS module through electrical connectors integrated into the optical backplane.

Additional capacity scaling can be achieved by occupying multiple adjacent slots on the optical backplane with a single OCS module possessing a larger radix. Further embodiments include deploying additional shuffle modules to independently serve subsets of OCS modules within the same optical backplane. Importantly, the described approach enables expansion of the optical switching network element within standard telecom racks or Open Rack v3 (ORv3) environments without requiring redesign of existing installed modules or optical backplane components.

The process 200 also permits selective utilization of liquid-cooled (LC) or non-liquid-cooled (non-LC) OCS modules within the same switching platform based on system cooling requirements. Replacement or upgrading of the centralized shuffle module can occur in the field without necessitating extensive re-cabling of existing optical connections to the OCS modules. In certain embodiments, the optical backplane includes a mechanical backplane supporting flexible optical trunk cable routing and simplified connector alignment. Additionally, the optical switching capacity can be incrementally expanded by employing a cable-as-you-grow approach, adding optical trunk cables based on evolving network demands.

Finally, the disclosed process 200 includes verifying optical signal continuity and performance of newly installed or reconfigured OCS modules and trunk cables through monitoring functionalities provided by a control module integrated within the network element. This integrated monitoring capability ensures reliable operation and simplified troubleshooting throughout the lifecycle of the scalable all-optical switch platform.

### Advantages

The disclosed scalable all-optical switch platform addresses several critical challenges in current optical network deployments by providing substantial operational, economic, and technical benefits.
(1) Simplified Deployment and Cabling: By utilizing a modular shuffle architecture integrated into a centralized shuffle module, the invention significantly reduces complexity associated with manual point-to-point fiber optic cabling. The adoption of high-density, multi-fiber connectors—such as EBO connectors—further streamlines initial deployment, substantially reducing labor costs and installation errors.
(2) Enhanced Maintainability and Serviceability: The platform’s modular design, incorporating easily replaceable OCS modules, shuffle modules, and configurable optical backplane, greatly simplifies maintenance activities. Individual modules can be serviced or replaced without extensive re-cabling, dramatically reducing downtime and operational disruptions. Field-replaceable components allow for rapid fault recovery and straightforward reconfiguration, significantly enhancing the overall reliability of data center operations.
(3) Scalability and Incremental Expansion: The flexible, modular nature of the platform permits easy scalability by simply adding or replacing modules without necessitating redesign or substantial reconfiguration. The mechanical backplane architecture supports incremental growth ("cable-as-you-grow"), accommodating a wide range of radix sizes (port counts), thereby offering a cost-effective approach to adapting system capacity and performance to evolving operational demands.
(4) Operational Flexibility and Future-Proof Design: The disclosed solution is inherently future-proof, with the ability to accommodate both liquid-cooled (LC) and non-liquid-cooled (non-LC) configurations, and to operate seamlessly in diverse rack environments (standard telecom racks as well as Open Rack v3 racks). This broad compatibility protects customer investments by ensuring that the optical infrastructure can evolve alongside technological advances and changing data center requirements without extensive modifications.
(5) Reduced Complexity and Improved Spatial Efficiency: By consolidating fiber interconnections into multi-fiber trunk cables and utilizing high-density blind-mate connectors, the platform drastically reduces faceplate space consumption compared to conventional single-fiber connector methods. This results in improved spatial efficiency within the rack, allowing higher density of optical ports and increased computational power per unit space.
(6) Improved Reliability and Reduced "Blast Radius": The architecture limits the potential impact of individual component failures by modularizing optical switching capabilities and connectivity. Fault isolation and rapid restoration capabilities inherent in this modular design minimize service disruptions, critical for maintaining the operational continuity required in high-performance computing environments, particularly for AI and ML workloads, where interruptions are costly.
(7) Configurable and Adaptable Backplane Architecture: The mechanical backplane implementation, distinct from traditional rigid PCB-based approaches, offers unprecedented adaptability. This design facilitates pre-configured factory settings tailored to specific customer deployments and allows straightforward on-site reconfiguration of optical and electrical harnesses, significantly enhancing adaptability to customer-specific and changing requirements.

Collectively, these advantages enable substantial improvements in operational efficiency, cost-effectiveness, reliability, scalability, and future adaptability, providing an optimal optical switching solution tailored for next-generation high-performance data center environments.

### Conclusion

In this disclosure, including the claims, the phrases “at least one of” or “one or more of,” when referring to a list of items, encompass any combination of those items, including any single item. For example, the expressions “at least one of A, B, or C,” “at least one of A, B, and C,” “one or more of A, B, or C,” and “one or more of A, B, and C” cover the possibilities of only A, only B, only C, any combination of A and B, A and C, B and C, or all three (A, B, and C). This also includes scenarios involving more or fewer elements than A, B, and C. Additionally, the terms “comprise,” “comprises,” “comprising,” “include,” “includes,” and “including” are intended to be open-ended and non-limiting, specifying essential elements or steps without excluding additional elements or steps—even where a claim or multiple claims contain more than one such term.

It should be understood that the drawings, descriptions, and examples provided herein merely illustrate various aspects and embodiments of the disclosure. Numerous modifications, changes, or arrangements may be made without departing from the spirit and scope of the disclosure. Although certain steps, operations, instructions, blocks, or similar elements (collectively referred to as “steps”) are depicted or described in a specific order, such ordering is not necessarily required unless explicitly stated. Nor does it imply that all depicted steps are essential to achieve the desired results. Extra steps may be performed before, after, concurrently, or interspersed with the illustrated or described steps. Multitasking, parallel processing, and other types of concurrent execution are also contemplated. Further, the separation of system components or steps described should not be interpreted as mandatory in all implementations; such components, steps, or elements may be integrated into a single configuration or distributed across multiple ones.

While this disclosure has been shown and described through specific embodiments and examples, those skilled in the art will recognize that many variations and modifications can provide equivalent functionality or yield comparable results. Such alternative embodiments and variations, even if not explicitly mentioned here, fall within the spirit and scope of this disclosure if they achieve the stated objectives and adhere to the underlying principles. Accordingly, they are envisioned and encompassed by the disclosure and protected by the associated claims. In other words, the present disclosure anticipates combinations and permutations of the described elements, operations, steps, methods, processes, algorithms, functions, techniques, modules, and circuits in any feasible sequence or arrangement—whether collectively, separately, or in subsets—thereby broadening the range of potential embodiments.

What is claimed is:

1. An optical switching network element, comprising:
a centralized shuffle module having a plurality of ingress and egress optical connectors configured to interface with external equipment;
a plurality of optical circuit switch (OCS) modules each configured as an X-by-X optical switch, where X is greater than 1; and
an optical backplane structure configured to optically interconnect the centralized shuffle module to each of the plurality of OCS modules via optical connectors and multi-fiber optical cables, wherein the centralized shuffle module provides optical shuffle functionality among the plurality of OCS modules.

2. The optical switching network element of claim 1, wherein the centralized shuffle module includes integrated shuffle functionality configured to provide optical cabling between the ingress and egress connectors and the plurality of OCS modules.

3. The optical switching network element of claim 1, wherein the optical connectors include blind-mate optical connectors mounted on the optical backplane structure.

4. The optical switching network element of claim 1, wherein the optical connectors include expanded beam optical (EBO) connectors.

5. The optical switching network element of claim 1, wherein the optical backplane structure includes a mechanical backplane supporting configurable arrangements of optical and electrical connectors.

6. The optical switching network element of claim 5, wherein the mechanical backplane enables pre-configuration of optical interconnections at a factory location and allows field reconfiguration of optical interconnections without altering the mechanical backplane structure.

7. The optical switching network element of claim 5, wherein the mechanical backplane includes separate zones for optical connectivity, electrical connectivity, and power distribution.

8. The optical switching network element of claim 1, wherein each of the plurality of OCS modules is configured to occupy a configurable number of slots on the optical backplane, wherein occupying more slots increases available optical connectivity.

9. The optical switching network element of claim 1, further comprising at least one control module configured to perform control, monitoring, and management functions, including operations, administration, maintenance, and provisioning (OAM&P).

10. The optical switching network element of claim 1, wherein the centralized shuffle module is configured to be field replaceable without disruption of optical interconnections to the plurality of OCS modules.

11. The optical switching network element of claim 1, wherein the optical backplane supports incremental addition of optical cables and connectors to increase capacity, enabling cable-as-you-grow expansion.

12. The optical switching network element of claim 1, wherein the centralized shuffle module includes connectors arranged in at least two distinct sets, a first set configured for connectivity to external compute racks, and a second set configured for internal connectivity to each OCS module.

13. The optical switching network element of claim 12, wherein the centralized shuffle module internally integrates optical cables configured to route optical signals between the first and second sets of connectors.

14. The optical switching network element of claim 1, wherein the network element is configured to be deployed in at least one of a standard telecom rack and an Open Rack v3 (ORv3) rack without module redesign.

15. The optical switching network element of claim 1, wherein each OCS module includes optical and electrical connectors arranged to align with corresponding connectors on the optical backplane for blind-mate connectivity.

16. The optical switching network element of claim 1, wherein the optical connectors include multi-fiber connectors supporting at least 144 fibers in a single connector, configured for high-density optical connectivity.

17. A method of expanding capacity of an optical switching network element, comprising:
providing a centralized shuffle module having ingress and egress optical connectors configured for external connectivity;
providing an optical backplane comprising optical connectors configured for modular interconnection;
installing at least one optical circuit switch (OCS) module into a slot of the optical backplane, the OCS module having a defined radix (X-by-X) optical switching capacity, where X > 1; and
optically interconnecting the OCS module to the centralized shuffle module using at least one multi-fiber optical trunk cable connected via the optical backplane connectors, thereby expanding total switching capacity of the network element.

18. The method of claim 1, further comprising incrementally installing additional OCS modules into available slots of the optical backplane to increase switching capacity over time.

19. The method of claim 1, further comprising installing OCS modules of different sizes and radix capacities within the optical backplane, thereby forming a heterogeneous switch platform.

20. The method of claim 1, further comprising upgrading switching capacity by replacing an existing OCS module with an OCS module having a larger radix without changing the optical backplane structure.
